(19) United States
(12) Patent Application Publication
(10) Pub. No.: US 2016/0357690 A1
(43) Pub. Date: Dec. 8, 2016

(54) INFORMATION PROCESSING DEVICE AND INFORMATION PROCESSING METHOD

(71) Applicant: MITSUBISHI ELECTRIC CORPORATION, Tokyo (JP)

(72) Inventors: Masahide KOIKE, Tokyo (JP); Kiyoyasu MARUYAMA, Tokyo (JP); Satoshi MICHIHATA, Tokyo (JP); Keiji UEMURA, Tokyo (JP); Yudai NAKAMURA, Tokyo (JP)

(73) Assignee: MITSUBISHI ELECTRIC CORPORATION, Tokyo (JP)

(21) Appl. No.: 15/114,643

(22) PCT Filed: Dec. 4, 2014
(86) PCT No.: PCT/JP2014/082070

§ 371 Date: Jul. 27, 2016

(30) Foreign Application Priority Data
Mar. 7, 2014 (JP) 2014-045048

(51) Int. Cl. G06F 13/28; G06F 13/40

(52) U.S. Cl. CPC G06F 13/28; G06F 13/404

(57) ABSTRACT

A storage section (101) configured to store data, a DMA section (106) configured to read video data from the storage section (101) by specifying an address and write them into the storage section (101), an address conversion rule storage section (104) configured to store an address conversion rule for converting the address specified by the DMA section (106), and an address conversion section (105) configured to convert the address specified by the DMA section (106) in accordance with the address conversion rule; the address conversion rule is a rule for converting addresses of a series of areas to addresses of the video data stored in a plurality of areas in the storage section (101); the address conversion section (105) includes an address conversion done-or-not determination section; and the address conversion done-or-not determination section determines, by comparing the address with a third area assigned to address conversion, whether the address conversion is done or not done.

### TECHNICAL FIELD

The present invention relates to information processing devices and information processing methods.

### BACKGROUND ART

As shown in FIG. 1, an information processing device 1 generally includes elements such as a CPU (Central Processing Unit) 2 which is a central processing device for processing information, a data storage section (also referred to as a memory) 3 which holds programs to be executed by the CPU 2 and data to be processed by the CPU 2, an input/output section 4 for connecting peripheral devices, DMA (Direct Memory Access) sections 5, 6 for making copies of data at high speed, and a data bus 7 for allowing these blocks to receive and send data.

When a large amount of data stored in a memory is copied to the same memory or a different memory in the information processing device 1, the DMA section 5 is used in order to reduce a load on the CPU 2. The DMA section 5 reads data to the memory, writes data from the memory, and copies data in place of the CPU 2. In general, the CPU 2 provides the DMA section 5 with a copy start instruction in which a storing address of source data (transfer source address), a copy destination address (transfer destination address), and an amount of data to be copied (transfer amount) are specified, thereby causing the DMA section 5 to read the data from the transfer source address and write the data to the transfer destination address. Furthermore, the DMA section 5 copies the source data to the copy destination by repeating these read and write processes up to the transfer amount with increasing the transfer source address and the transfer destination address.

FIG. 2 is a schematic diagram showing a way of DMA transfer by the DMA section 5. The CPU 2 sets transfer source address sa, transfer destination address da, and transfer amount sz to the DMA section 5. The DMA section 5 sequentially reads data starting from address sa up to amount sz from the memory and writes the data in an area starting from address da. The flow of this processing is shown in FIG. 3A. In this way, the data are copied.

FIGS. 4A and 4B are schematic diagrams showing the relationship between settings of the DMA by the CPU 2, and memory reading and memory writing by the DMA section 5.

As shown in FIG. 4B, while the DMA section 5 is carrying out memory reading and writing, the CPU 2 does not need to execute memory reading and writing and can perform other processing. Therefore, in comparison with a case in which the CPU 2 executes the memory reading and writing, a load on the CPU 2 is reduced by the DMA section 5.

There is also a case where the information processing device 1 needs to copy data dispersed in a number of different areas within the same memory or between a plurality of memories in a course of information processing together. In this case, as shown in FIGS. 5A and 5B, the CPU 2 sets, to the DMA section 5, a transfer source address, a transfer destination address, and a transfer amount for each area. Since a load on the CPU 2 increases with the CPU 2 carrying out such setting, a descriptor-compliant DMA section 6 is used.

Usually, descriptors are often written in part of area in a memory, information of the transfer source address, transfer destination address, and transfer amount corresponding to each area of data to be copied is written, and the number of the transfer source addresses, the transfer destination address, or the transfer amount is equal to the number of the areas to be copied.

FIGS. 6A and 6B are schematic diagrams showing data stored in the data storage section 3 when the descriptor-compliant DMA section 6 is used. In descriptor area DA shown in FIG. 6A, descriptor information DT shown in FIG. 6B is stored, for example.

In descriptor information DT, descriptors including transfer source address sai, transfer destination address dai, and transfer amount szi (i=1, 2, 3, . . . , N; N is a positive integer) are written, and the number of the descriptors is equal to the number of the areas (N in the case of FIG. 6).

As shown in FIG. 6A, when the CPU finishes setting descriptor information DT and provides the DMA section 6 with a copy start instruction, the DMA section 6 reads each of the descriptors sequentially from descriptor information DT and copies data according to each descriptor. The DMA section 6 copies areas 1 to N sequentially in such a manner that it first copies data of transfer amount sz1 from transfer source address sa1 to transfer destination address da1 and next copies data of transfer amount sz2 from transfer source address sa2 to transfer destination address da2. A flow of this process is shown in FIG. 3B. Timing charts of this process are shown in FIGS. 7A and 7B. After the CPU 2 first sets descriptor information DT and provides the DMA section 6 with a copy start instruction, it can perform other processing until the DMA section 6 finishes copying the data of areas 1 to N.

By using the descriptor-compliant DMA section 6 as described above, since the DMA section 6 sequentially copies data dispersed in different areas in accordance with the descriptors, the CPU 2 can omit operations of setting DMA each time for each area and reduce its load.

Patent reference 1 discloses a DMA transfer device compliant with descriptors. This DMA transfer device further accepts NOP commands, which specifies that DMA transfer is not performed, as the descriptors. Specifically, if the NOP command is specified as the descriptor, this DMA transfer device issues an interrupt signal to the CPU and does not perform the DMA transfer, and when the CPU detects the interrupt signal from the DMA transfer device, it performs data transfer in accordance with the descriptor.

### PRIOR ART REFERENCES

### Patent Reference

Patent reference 1: Japanese Patent Publication No. 4881140 (paragraphs 0065 to 0074)

### SUMMARY OF THE INVENTION

### Problems to be Solved by the Invention

In the DMA transfer device compliant with descriptors which is disclosed in Patent reference 1, the CPU needs to manage a transfer source address, a transfer destination address, and a transfer amount for each area to be copied and set them as descriptors. Accordingly, there are problems that as the number of areas to be copied increases, not only a load of managing the addresses and transfer amounts on the CPU but also a load of setting the descriptors increases.

It is an object of the present invention to solve the problems as described above and to reduce a load of managing the transfer source addresses, the transfer destination addresses, and the transfer amounts of the areas to be copied even if the number of areas to be copied becomes large.

### Means for Solving the Problem

An information processing device according to one aspect of the present includes a storage section configured to store video data, a DMA section configured to read video data from the storage section by specifying an address and write the read video data into the storage section or another storage section different from the storage section, an address conversion rule storage section configured to store an address conversion rule for converting the address specified by the DMA section, and an address conversion section configured to convert the address specified by the DMA section in accordance with the address conversion rule; the address conversion rule is a rule for converting addresses of a series of areas to addresses of the video data stored in a plurality of areas in the storage section; the address conversion section includes an address conversion done-or-not determination section; and the address conversion done-or-not determination section determines, by comparing the address with a third area assigned to address conversion, whether the address conversion is done or not done.

An information processing method according to one aspect of the present invention includes an address specification step of specifying an address of video data to be read from a storage section, an address conversion step of converting the address specified in the address specification step in accordance with an address conversion rule, a readout step of reading video data stored at the address converted in the address conversion step from the storage section, and a step of writing the video data read in the readout step into the storage section or another storage section different from the storage section; the address conversion rule is a rule for converting addresses of a series of areas to addresses of the video data stored in a plurality of areas of the storage section; in the address conversion step, whether address conversion is done or not done is determined by comparing the address with a third area assigned to the address conversion.

### Effects of the Invention

According to one aspect of the present invention, even if the number of areas to be copied becomes large, they can be handled as one area, and consequently a load of managing the transfer source addresses, the transfer destination addresses, and the transfer amounts of the areas to be copied can be reduced.

### BRIEF DESCRIPTION OF THE DRAWINGS

FIG. 1 is a block diagram schematically showing a configuration of the conventional information processing device.

FIG. 2 is a schematic diagram showing a way of DMA transfer in the conventional art.

FIGS. 3A and 3B are flowcharts showing processes of DMA transfer in the conventional art.

FIGS. 4A and 4B are schematic diagrams showing a relationship between settings of DMA and memory reading and memory writing in the conventional art.

FIGS. 5A and 5B are schematic diagrams showing a relationship between settings of DMA and memory reading and memory writing in the conventional art.

FIGS. 6A and 6B are schematic diagrams showing an example of data stored in a data storage section when the conventional descriptor-compliant DMA section is used.

FIGS. 7A and 7B are schematic diagrams showing a relationship between settings of descriptor and memory reading and memory writing in the conventional art.

FIG. 8 is a block diagram schematically showing an example of a configuration of an information processing device according to a first embodiment.

FIGS. 9A and 9B are schematic diagrams for illustrating target data to be processed and processed data in the first embodiment.

FIG. 10 is a schematic diagram showing an example of a CCTV system in the first embodiment.

FIG. 11 is a schematic diagram showing the configuration of an RTP packet in the first embodiment.

FIGS. 12A and 12B are schematic diagrams showing states of copying data without address conversion and copying data with address conversion in the first embodiment.

FIG. 13 is a schematic diagram showing an example of an address conversion rule in the first embodiment.

FIG. 14 is a block diagram schematically showing an example of a configuration of an address conversion section in the first embodiment.

FIG. 15 is a block diagram schematically showing an example of a configuration of an information processing device according to a second embodiment.

FIGS. 16A and 16B are schematic diagrams for illustrating transfer of target data to be processed in the second embodiment.

FIGS. 17A and 17B are schematic diagrams for illustrating target data to be processed and processed data in the second embodiment.

FIGS. 18A and 18B are schematic diagrams showing states of copying data without address conversion and copying data with address conversion in the second embodiment.

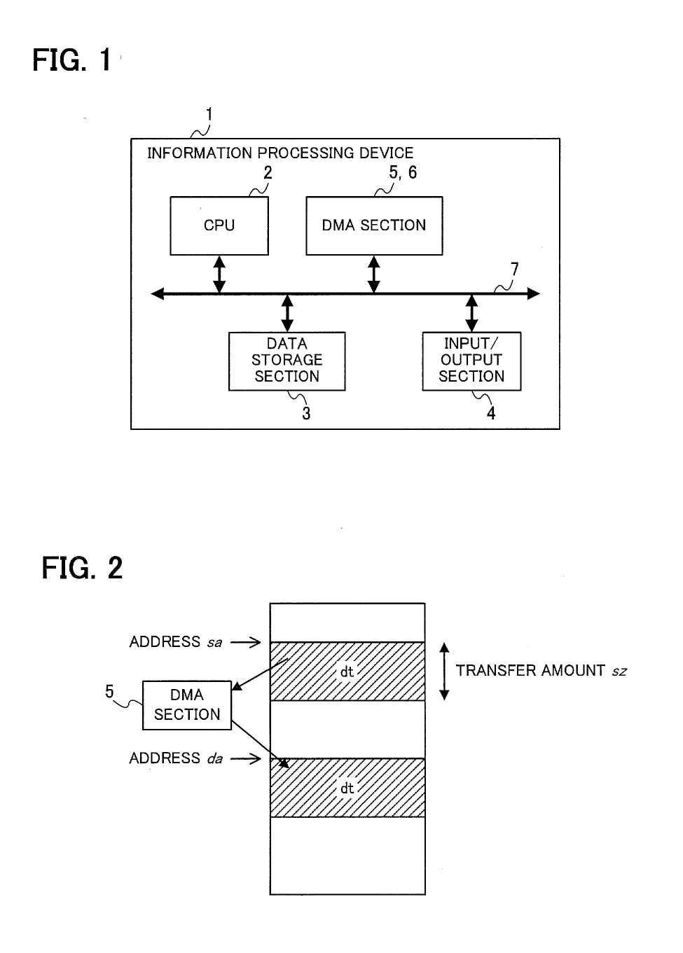

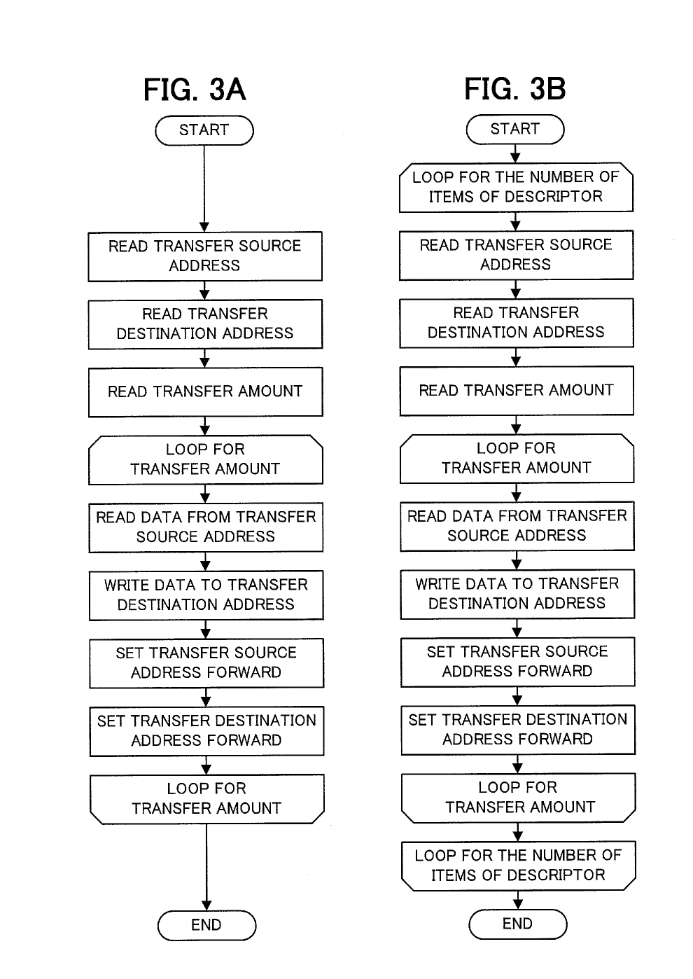

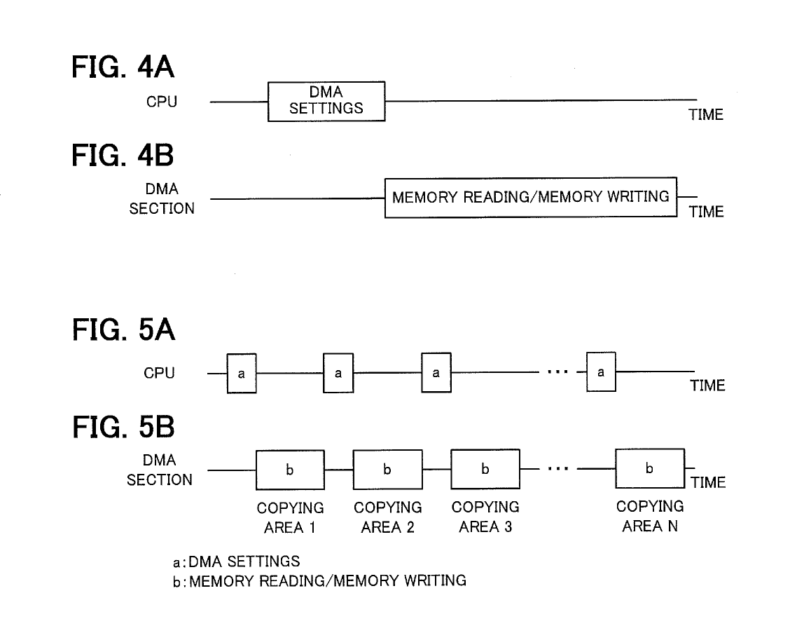

### MODE FOR CARRYING OUT THE INVENTION

### First Embodiment

FIG. 8 is a block diagram schematically showing an example of a configuration of an information processing device 100 according to a first embodiment. The information processing device 100 shown in FIG. 8 is used, for example, to process data for recording and reproducing monitoring video in a monitoring recorder.

The information processing device 100 includes a data storage section 101, a CPU 102, a data processing section 103, an address conversion rule storage section 104, an address conversion section 105, a DMA section 106, and a data bus 107.

The data storage section 101 is a storage section which stores data and programs.

The CPU 102 is a control section which controls individual sections in the information processing device 100. For example, the CPU 102 executes the programs stored in the data storage section 101 to perform reading or writing of the data from or to the data storage section 101, arithmetic processing, and control processing.

The data processing section 103 executes part of the processing of the CPU 102 in place of the CPU 102 to reduce a load on the CPU 102. For example, the data processing section 103 processes data stored in the data storage section 101. Then, the CPU 102 continues subsequent processing by using the data that the data processing section 103 has processed.

In addition, the data processing section 103 generates an address conversion rule by associating addresses of a plurality of areas where the processed data are stored in the data storage section 101 with addresses of a series of unused areas where no data are stored in the data storage section 101. Then, the data processing section 103 stores the generated address conversion rule in the address conversion rule storage section 104. This series of unused areas where no data are stored in the data storage section 101 is referred to as an address conversion area.

The data processing section 103 notifies the CPU 102 of the address conversion area. Then, the CPU 102 instructs the DMA section 106 to transfer the data of the address conversion area.

The address conversion rule storage section 104 holds the address conversion rule set by the data processing section 103. The address conversion rule is a rule of converting addresses specified by the DMA section 106.

The address conversion section 105 converts addresses specified by the DMA section 106 in accordance with the address conversion rule stored in the address conversion rule storage section 104. For example, the address conversion section 105, by referring to the address conversion rule stored in the address conversion rule storage section 104, performs address conversion if a address specified by the DMA section 106 is contained in the address conversion area of the data storage section 101, and does not perform address conversion if it is not contained.

In response to a start instruction from the CPU 102, the DMA section 106 specifies an address, reads data stored in the data storage section 101, and writes (copies) the data into a different area of the data storage section 101. Here, the address specified by the DMA section 106 is converted by the address conversion section 105 as needed.

The operation of the sections of the information processing device 100 will be described below in detail.

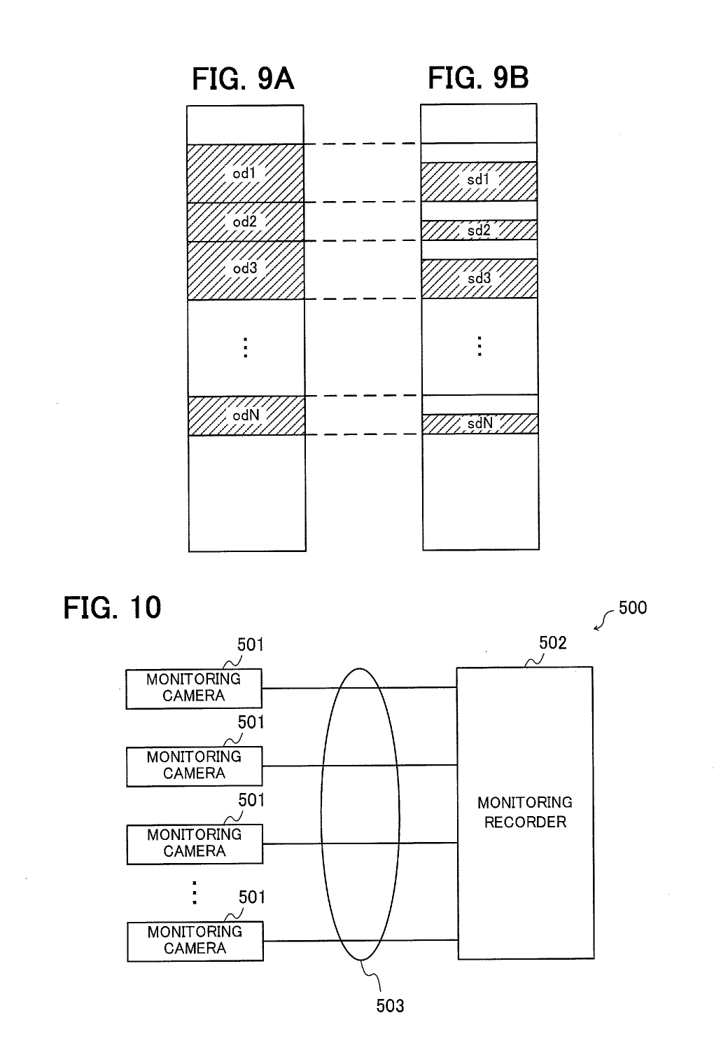

The CPU 102 notifies the data processing section 103 of places where target data to be processed are stored in the data storage section 101 in order that the data processing section 103 may execute part of the processing. For example, the CPU 102 notifies the data processing section 103 of areas od1, od2, od3, . . . , odN where target data to be processed are stored, as shown in FIG. 9A. The notification from the CPU 102 to the data processing section 103 is made, for example, by writing the information of the areas where the data are stored into registers in the data processing section 103.

In response to a data processing start instruction from the CPU 102, the data processing section 103 starts processing data. Here, as an example of the data processing, a CCTV (closed-circuit television) system 500 shown in FIG. 10 will be explained. The CCTV system 500 is configured by a plurality of monitoring cameras 501 and a monitoring recorder 502 connected by a network 503, for example, as shown in FIG. 10. For some monitoring purposes, a large number of monitoring cameras 501 are connected to the monitoring recorder 502. Monitoring video recorded by the monitoring camera 501 is encoded according to a format such as H.264, and a video stream is generated. The generated video stream is sent from the monitoring camera 501 in RTP (Real-time Transport Protocol) packets, for example. These RTP packets are transmitted via the network 503 and received by the monitoring recorder 502. The monitoring recorder 502 performs processing such as removing the RTP headers from the received RTP packets and extracting out the video stream, and then records it in the storage device such as a hard disk drive in the monitoring recorder 502.

In this case, the monitoring recorder 502 corresponds to the information processing device 100. It is assumed that the received RTP packets are stored in the data storage section 101.

Here descriptions are given on the assumption that the data processing section 103 removes the RTP headers from the RTP packets and extracts the video stream.

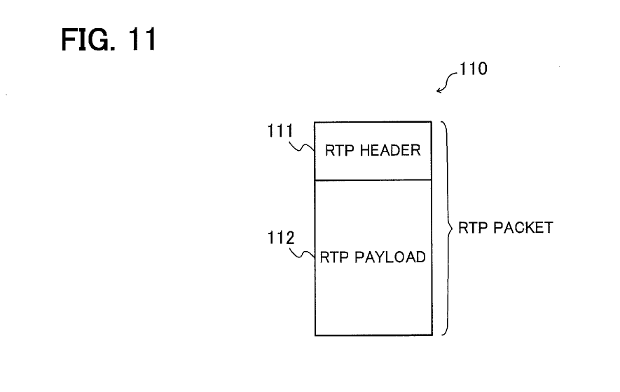

As shown in FIG. 11, an RTP packet 110 includes an RTP header 111 and an RTP payload 112. The video stream is stored in the part corresponding to the RTP payload 112, and the data processing section 103 extracts just the part corresponding to the RTP payload 112 from the RTP packet 110.

It is assumed here that each of areas od1, od2, od3, . . . , odN shown in FIG. 9A is a single RTP packet. The data processing section 103 processes them sequentially from area od1. The data processing section 103 first reads information in the RTP header from the RTP packet stored in area od1. Since the content of the RTP header indicates the storage location of the RTP payload, the data processing section 103 assumes the area to be area sd1 where the video stream is stored, as shown in FIG. 9B. The data processing section 103 processes areas od2, od3, . . . in the same manner and obtains areas sd2, sd3, . . . , sdN, where the video stream is stored, as shown in FIG. 9B.

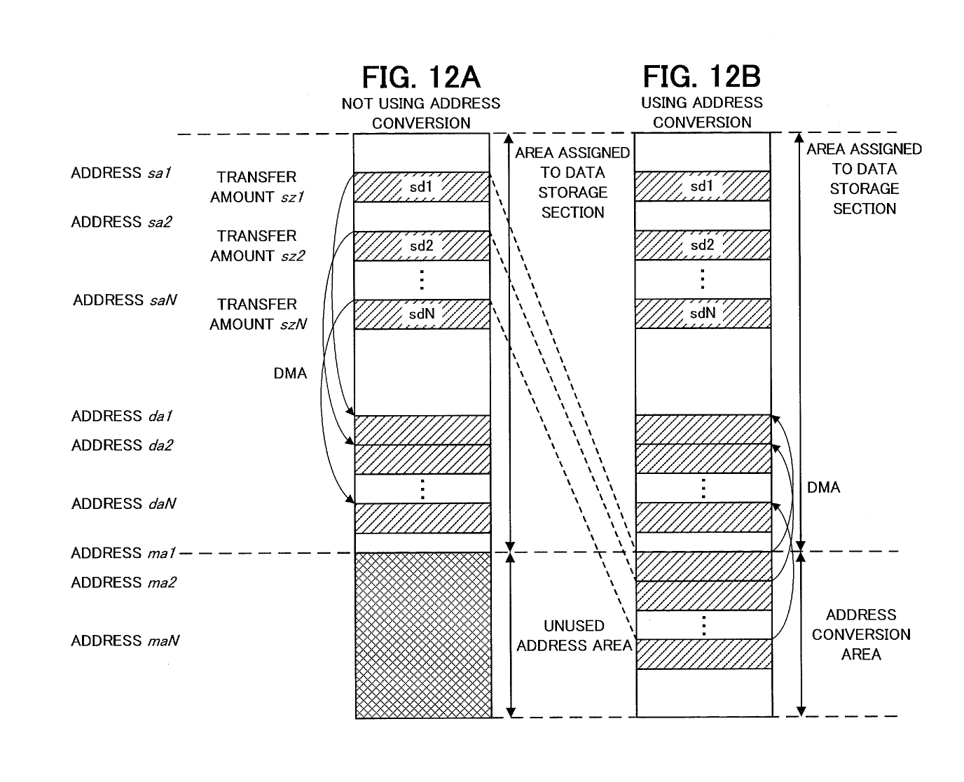

When the processing by the data processing section 103 proceeds to a predetermined point of time, for example, when the processing of a predetermined amount of data or a predetermined group of data items (a predetermined number of data items) finishes, the data processing section 103 stores an address conversion rule in the address conversion rule storage section 104. The address conversion rule is generated so that address conversion as shown in FIG. 12B, for example, may be performed. FIG. 12A shows a case of copying data without the address conversion. FIG. 12B shows a case of copying data with the address conversion. As shown in FIG. 12B, when the address conversion is performed, an address area that is not used in FIG. 12A is used as an address conversion area. By using the address conversion area like this, the address conversion is performed in a way that areas sd1, sd2, . . . , sdN storing the video stream look like being stored at successive addresses. In FIG. 12B, areas sd1 to sdN are successively assigned to unused addresses in the unused address area, such as area sd1 to address ma1 and area sd2 to address ma2. By doing this, the video stream data can be handled as if they were stored in a continuous area.

At each predetermined point of time, such as each time the processing of a predetermined amount of data or a predetermined group of data items (a predetermined number of data items) is completed, the data processing section 103 stores, in the address conversion rule storage section 104, part of the address conversion rule (hereafter also referred to as a partial address conversion rule). Therefore, the address conversion rule in the address conversion rule storage section 104 is not fixed, and the contents vary depending on the processing of the data processing section 103 proceeds. In addition, the partial address conversion rules that become unnecessary with data copied by the DMA section 106 described later are eliminated (deleted) from the address conversion rule storage section 104. Since the partial address conversion rules are deleted in accordance with the state of transfer by the DMA section 106 like this, the address conversion rule storage section 104 can be kept from becoming unnecessarily large.

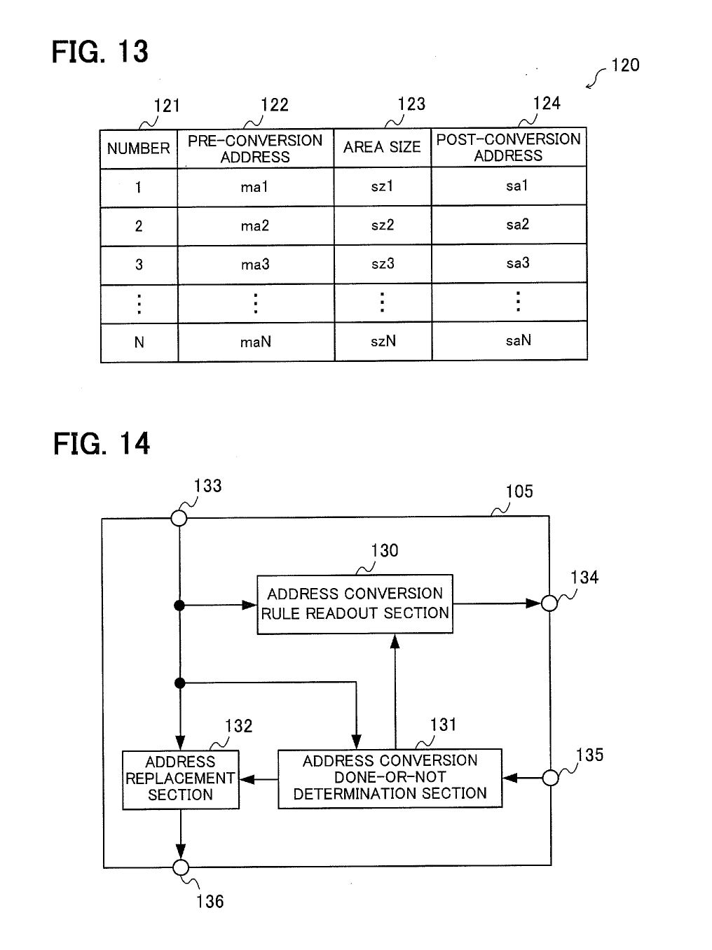

FIG. 13 is a schematic diagram showing an example of the address conversion rule stored in the address conversion rule storage section 104. The address conversion rule is set in a form like an address conversion rule table 120, as shown in FIG. 13, for example.

The address conversion rule table 120 has a number column 121, a pre-conversion address column 122, an area size column 123, and a post-conversion address column 124. Here a single set of information items stored in each record is a partial address conversion rule.

The number column 121 stores identification numbers 1 to N as partial address conversion rule identification information for identifying individual partial address conversion rules.

The pre-conversion address column 122 stores pre-conversion addresses ma1 to maN.

The area size column 123 stores sizes sz1 to szN of individual data items stored at pre-conversion addresses ma1 to maN.

The post-conversion address column 124 stores post-conversion addresses sa1 to saN.

As above, storing the address conversion rule in the form described above makes it possible for the address conversion section 105 to perform address conversion by means of simple hardware.

The address conversion section 105 executes address conversion in accordance with the address conversion rule stored in the address conversion rule storage section 104. When bus access is made to an address area identified by the pre-conversion address column 122 and the area size column 123 of the address conversion rule table 120 stored in the address conversion rule storage section 104, the address conversion section 105 carries out address conversion in accordance with the address conversion rule table 120. On the other hand, when bus access is made to an area other than the address area identified by the pre-conversion address column 122 and the area size column 123 of the address conversion rule table 120, the address conversion section 105 does not execute address conversion. Address conversion is therefore performed only when a corresponding address conversion rule is present.

For example, in the example in FIG. 13, when bus access is made to an address within an area of addresses from ma1 to (ma1+sz1−1), the address conversion section 105 converts the address to be accessed actually to an address within an area of addresses from sa1 to (sa1+sz1−1). The same processing is done for the areas of addresses from ma2 to (ma2+sz2−1), . . . , from maN to (maN+szN−1). If the address to which bus access is made is not included in any of the areas of addresses from ma1 to (ma1+sz1−1), from ma2 to (ma2+sz2−1), . . . , from maN to (maN+szN−1), the address conversion section 105 does not carry out address conversion.

FIG. 14 is a block diagram schematically showing an example of the configuration of the address conversion section 105. As shown in FIG. 14, the address conversion section 105 includes an address conversion rule readout section 130, a address conversion done-or-not determination section 131, and an address replacement section 132.

From a terminal 133 in FIG. 14, pre-conversion address a0 is input. When pre-conversion address a0 is input, the address conversion rule readout section 130 outputs a readout signal through a terminal 134 to the address conversion rule storage section 104. In this readout signal, the identification number of a partial address conversion rule is specified from 1 to N in sequence, for example. Therefore, the address conversion rule storage section 104 returns to the address conversion section 105 the partial address conversion rule (pre-conversion address mai, area size szi, post-conversion address sai) corresponding to specified identification number i (i is an integer satisfying 1≦i≦N).

When the address conversion rule readout section 130 read a partial address conversion rule, if copying of data of the address area corresponding to another partial address conversion rule that has already been read is finished, it caused the address conversion rule storage section 104 to delete the corresponding record from the address conversion rule table and thereby being able to reduce the storage amount.

The partial address conversion rule returned from the address conversion rule storage section 104 is input from a terminal 135 of the address conversion section 105 and input to the address conversion done-or-not determination section 131. The address conversion done-or-not determination section 131 compares pre-conversion address a0 input from the terminal 133 with the partial address conversion rule input from the terminal 135, and determines whether address conversion is done. For example, if address a0 satisfies this condition: address mai≦address a0≦(address mai+szi−1), for example, the address conversion done-or-not determination section 131 determines that the address conversion by this partial address conversion rule is done. On the other hand, if the condition is not satisfied, the address conversion done-or-not determination section 131 determines that the address conversion by this partial address conversion rule is not done. If the address conversion is done, the address conversion done-or-not determination section 131 outputs address sai+(address a0−address mai), for example, as a post-conversion address, to the address replacement section 132. If the determination result of the address conversion done-or-not determination section 131 indicates that the address conversion is done, the address replacement section 132 outputs the post-conversion address input from the address conversion done-or-not determination section 131. If the determination result of the address conversion done-or-not determination section 131 indicates that the address conversion is not done, the address replacement section 132 outputs pre-conversion address a0 input from the terminal 133. The address output from the address replacement section 132 is output through a terminal 136 from the address conversion section 105, and the output address makes it possible to read out from the data storage section 101.

When the data processing section 103 has finished storing the address conversion rule into the address conversion rule storage section 104, it notifies the CPU 102 of the completion of data processing and of the address conversion area as the storage location of the processed data. In the example shown in FIG. 12B, for example, address ma1 and total size szA of the data stored in areas sd1 to sdN are informed. Here, szA=sz1+sz2+ . . . +szN.

When the CPU 102 receives the notification of completion of data processing from the data processing section 103, it performs settings for copying the data of the processing result to the DMA section 106. In the example shown in FIG. 12B, for example, address ma1 is set as the DMA transfer source address, da1 is set as the DMA transfer destination address, and szA is set as the transfer amount. Here, the transfer source area is specified by address ma1 and transfer amount szA, and has become a continuous area. Transfer destination address da1 is set to a place convenient for the CPU 102 to perform subsequent processing. After the CPU 102 has finished the setting of the DMA section 106, it instructs the DMA section 106 to start copying. These settings and instruction from the CPU 102 to the DMA section 106 are made by setting registers in the DMA section 106. In the meantime, the address conversion section 105 does not execute address conversion and allows register write access from the CPU 102 to the DMA section 106 to pass directly.

According to the copy start instruction from the CPU 102, the DMA section 106 copies data. Data are read in order of addresses, starting from transfer source address ma1 specified by the CPU 102, and the read data are written sequentially, starting from transfer destination address da1 specified by the CPU 102. When copying of data of transfer amount szA specified by the CPU 102 is completed, the CPU 102 is notified of the completion of data copying.

This process makes a state in which the data in areas sd1 to sdN storing the video stream are stored continuously in order from address da1 specified by the CPU 102. In this process, the CPU 102 has specified just transfer source address ma1, transfer destination address da1, and transfer size szA, and does not need to manage the transfer source address, transfer destination address, and transfer amount for each of areas sd1 to sdN storing the video stream, and descriptor settings for DMA become unnecessary or simple.

When the data processing section 103 stores the partial address conversion rules in the address conversion rule storage section 104, if the identification numbers have been set for areas sd1, sd2, . . . , sdN in FIG. 12B according to order in which the DMA section 106 reads out, or in other words, in a way that order for the DMA section 106 to read out is recognizable, it becomes easy to refer to the addresses when the address conversion section 105 executes address conversion with reference to the address conversion rule table 120. In the example shown in FIG. 13, for example, if the partial address conversion rules are stored in a way that DMA is performed in order of identification numbers such as 1, 2, 3, . . . , the partial address conversion rule of identification number 1 is referred to for the address conversion in the first DMA transfer; as the DMA transfer proceeds, the identification number also proceeds from 1 to 2, 3, . . . ; and therefore it becomes easy to refer to the addresses.

In this case, the address conversion rule readout section 130 in the address conversion section 105 is set to refer to the partial address conversion rules in the address conversion rule table 120 sequentially from identification number 1 when the DMA operation starts. In addition, the address conversion rule readout section 130 obtains from the address conversion done-or-not determination section 131 pre-conversion address ma1 and area size sz1 corresponding to identification number 1 currently under processing. Then, when pre-conversion address a0 input from the terminal 133 reaches or exceeds address ma1+sz1, it is judged to be off the range of the partial address conversion rule of identification number 1, and the referencing operation is changed to refer to the subsequent partial address conversion rules sequentially from identification number 2. In this case, the address conversion rule readout section 130 obtains from the address conversion done-or-not determination section 131 pre-conversion address ma2 and area size sz2 corresponding to identification number 2 currently under processing. Then, when the range of the partial address conversion rule of identification number 2 is exceeded, the address conversion rule readout section 130 changes the referencing operation to refer to the subsequent partial address conversion rules sequentially from identification number 3; in a way like that, the reference start identification number is changed one after another. This makes it easy for the address conversion section 105 to refer to the address conversion rule table 120, and the time needed for address conversion can be reduced. This way can be implemented by so simple hardware that cost of the device is not affected. Incidentally, the address conversion rule readout section 130 may also be configured to read the whole address conversion rule table 120 stored in the address conversion rule storage section 104. In this case, the address conversion rule table 120 is held in a memory (not shown in the drawings) in the address conversion done-or-not determination section 131.

In the configuration shown in FIG. 8, the address conversion rule storage section 104 and the data storage section 101 may be formed in a single storage device. In this case, the storage device for implementing the address conversion rule storage section 104 and the storage device implementing the data storage section 101 may be incorporated into a single device, the hardware configuration can be simplified further, and cost of the device can be reduced. In this case, the address conversion rule storage section 104 may be disposed in the data storage section 101, for example. Further, in FIG. 8, the DMA section 106 may be connected also to the data bus 107 so that an instruction or the like from the CPU 102 can be input directly to the DMA section 106, not through the address conversion section 105.

As described above, according to the first embodiment, even if the number of areas to be copied becomes large, a load of managing the transfer source addresses, transfer destination addresses, and transfer amounts for the areas to be copied can be reduced. If descriptors are used, the writing amount of the descriptors set by the CPU 102 can be reduced, and a load of setting descriptors on the CPU 102 can be reduced.

In the CCTV system 500 shown in FIG. 10, the reduced a load on the CPU 102 allows the CPU 102 to process video streams from a greater number of monitoring cameras 501 and makes it possible to connect a large number of monitoring cameras 501 to the monitoring recorder 502.

### Second Embodiment

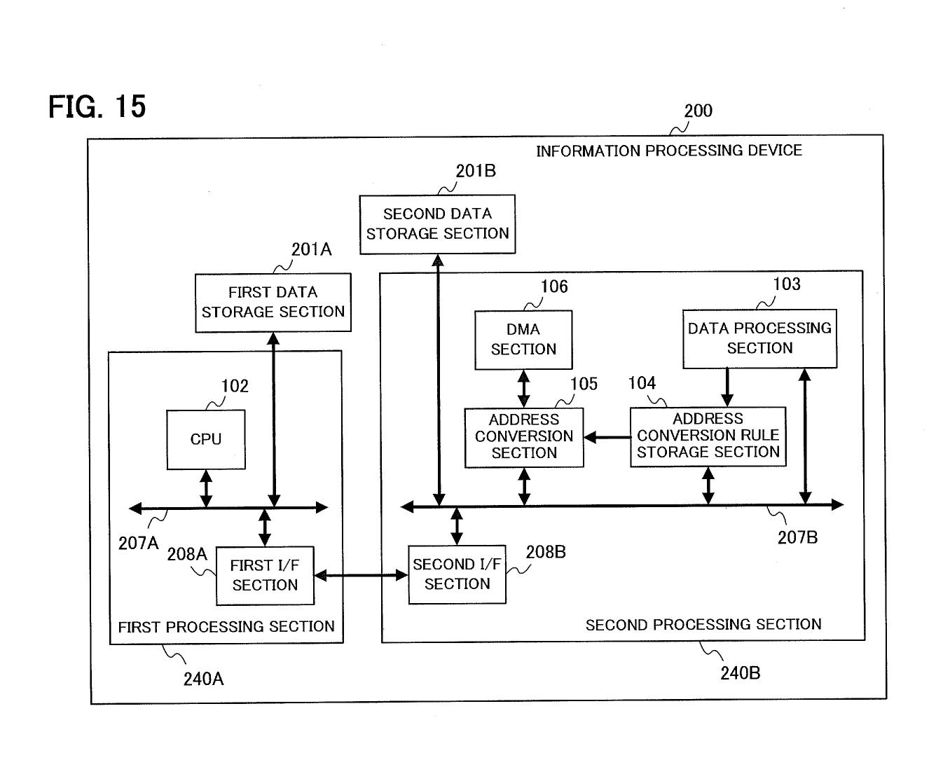

FIG. 15 is a block diagram schematically showing an example of a configuration of an information processing device 200 according to a second embodiment. The information processing device 200 shown in FIG. 15 is used, for example, to process data for recording and reproducing monitoring video in a monitoring recorder. The second embodiment is configured to use an inexpensive small-scale FPGA to perform part of the processing of the CPU in place of the CPU, in order to reduce a load on the CPU. By reducing a load on the CPU, this configuration makes it possible to use a low-priced CPU and can reduce cost of the entire information processing device 200.

The information processing device 200 includes a first data storage section 201A, a second data storage section 201B, a first processing section 240A, and a second processing section 240B.

The first processing section 240A includes a CPU 102, a first data bus 207A, and a first interface section (hereafter referred to as a first I/F section) 208A. The first processing section 240A uses the first data storage section 201A as a temporary storage device for programs and data.

The second processing section 240B includes a DMA section 106, a data processing section 103, an address conversion section 105, an address conversion rule storage section 104, a second data bus 207B, and a second interface section (hereafter referred to as a second I/F section) 208B. The second processing section 240B uses the second data storage section 201B as a temporary storage device for data processing.

Here, the first processing section 240A is a device such as an SoC (System-on-a-Chip) equipped with the CPU 102, and the second processing section 240B can be implemented by a custom circuit with an FPGA (Field Programmable Gate Array) or the like.

Among the components of the information processing device 200 shown in FIG. 15, the CPU 102, the DMA section 106, the data processing section 103, the address conversion section 105, and the address conversion rule storage section 104 have almost the same functions as the components denoted by identical reference characters in the information processing device 100 according to the first embodiment.

The first data storage section 201A stores data and programs to be used by the CPU 102.

The CPU 102 executes the programs stored in the data storage section 201A to perform reading or writing of the data from or into the data storage section 201A, arithmetic processing, and control processing.

The first I/F section 208A and the second I/F section 208B are interfaces for sending and receiving data between the first processing section 240A and the second processing section 240B. For example, they perform communication according to a standard such as PCI (Peripheral Component Interconnect)—Express and USB (Universal Serial Bus), to transfer data at a high speed between the first processing section 240A and the second processing section 240B.

In order to cause the data processing section 103 to perform part of the processing of the CPU 102 in place of the CPU 102, the DMA section 106 reads data targeted for the processing from the first data storage section 201A, transfers the data from the first processing section 240A to the second processing section 240B through the first I/F section 208A and the second I/F section 208B, and stores the transferred data in the second data storage section 201B.

In addition, according to a start instruction from the CPU 102, the DMA section 106 specifies addresses to read data stored in the second data storage section 201B and copies the data into the first data storage section 201A. Here, the addresses specified by the DMA section 106 are converted by the address conversion section 105 as needed.

The data processing section 103 executes part of the processing of the CPU 102 in place of the CPU 102 and reduces a load on the CPU 102. It reads target data stored in the second data storage section 201B and performs processing in place of the CPU 102. The data processed by the data processing section 103 are transferred from the second data storage section 201B to the first data storage section 201A by the DMA section 106. Then, the CPU 102 uses the processed data that have been processed by the data processing section 103 and stored in the first data storage section 201A to perform the subsequent processing continuously.

The address conversion rule storage section 104 holds an address conversion rule set by the data processing section 103, in accordance with the result of processing by the data processing section 103.

The address conversion section 105 performs address conversion in accordance with the address conversion rule stored in the address conversion rule storage section 104.

The operation of the components of the information processing device 200 will be described in detail below.

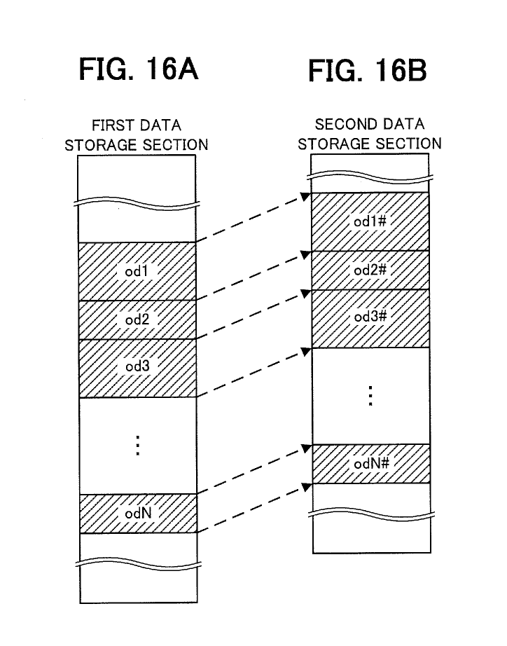

In order to cause the data processing section 103 to execute part of the processing, the CPU 102 sets the DMA section 106 to copy target data to be processed in the first data storage section 201A into the second data storage section 201B. For example, the CPU 102 sets it so that areas od1, od2, od3, . . . , odN storing the target data to be processed in the first data storage section 201A, as shown in FIG. 16A, may be copied to areas od1#, od2#, od3#, . . . , odN# of the second data storage section 201B, as shown in FIG. 16B. Here, areas od1, od2, od3, . . . , odN are areas storing the results of the preceding processing by the CPU 102, and areas od1#, od2#, od3#, . . . , odN# are allocated to unused areas usable in the second data storage section 201B.

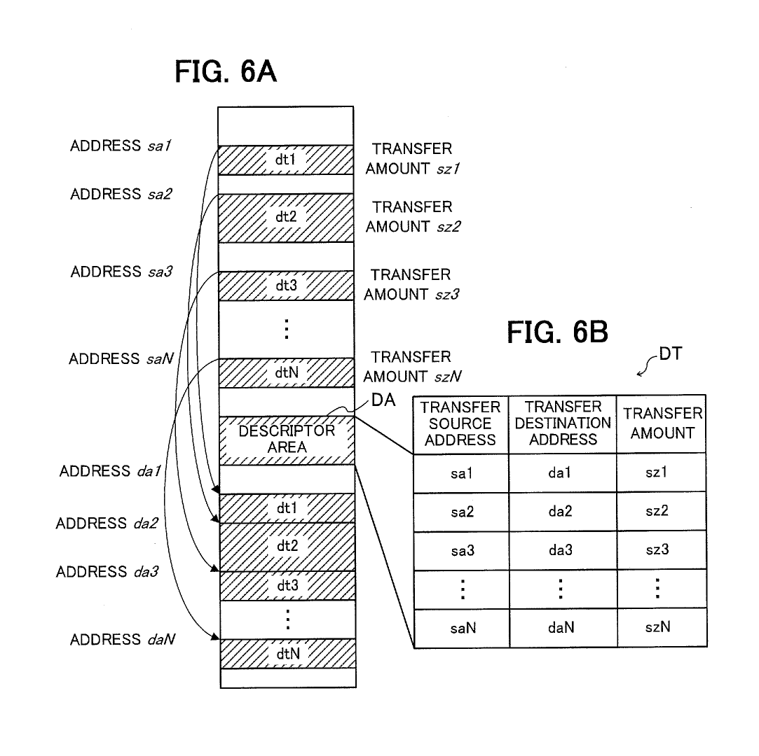

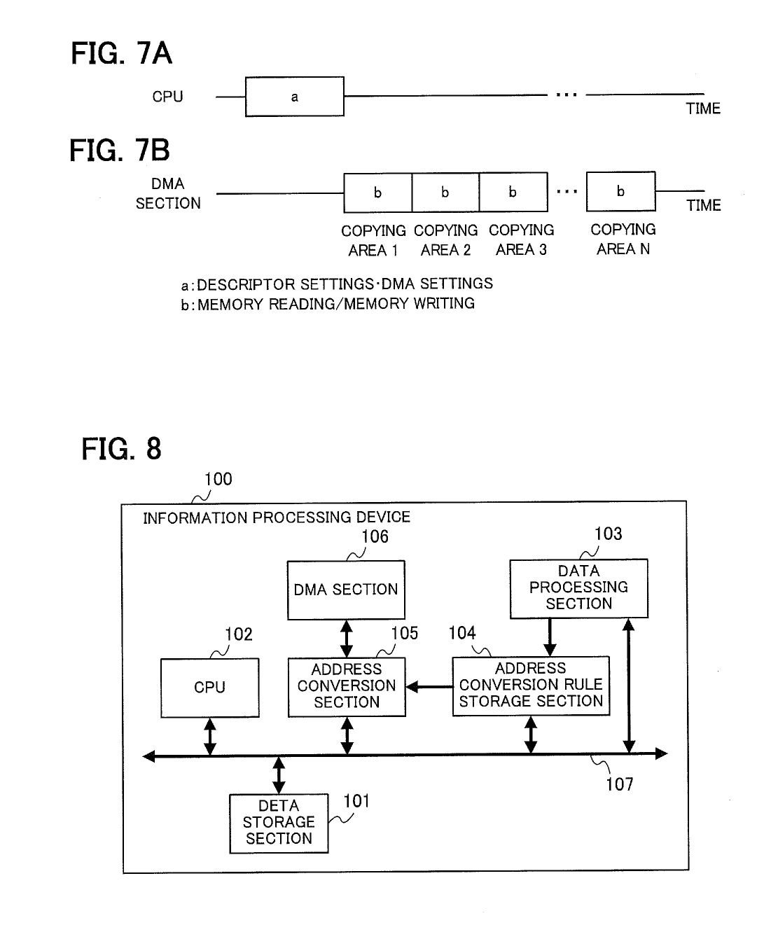

Transfer by the DMA section 106 is performed by one-off DMA as shown in FIG. 2, or by DMA using descriptors as shown in FIG. 6. If areas od1, od2, od3, . . . , odN are allocated to consecutive addresses and if areas od1#, od2#, od3#, . . . , odN# are allocated to consecutive addresses, transfer is performed by the one-off DMA. If they are allocated to non-consecutive addresses, the DMA using descriptors is used.

Setting of the DMA section 106 by the CPU 102 is performed through the first I/F section 208A and the second I/F section 208B, by writing registers in the DMA section 106. When the CPU 102 has finished the setting of the DMA section 106, it instructs the DMA section 106 to start copying. These setting and instruction from the CPU 102 to the DMA section 106 are made through the first I/F section 208A and the second I/F section 208B, by setting registers in the DMA section 106. At this time, address conversion by the address conversion section 105 is not performed, and register write access from the CPU 102 to the DMA section 106 is allowed to pass directly.

According to the instruction from the CPU 102, the DMA section 106 copies target data to be processed from the first data storage section 201A to the second data storage section 201B. When the DMA section 106 has finished copying data, it notifies the CPU 102 of the completion of data copying through the second I/F section 208B and the first I/F section 208A. Receiving the notification of the completion of the data copying, the CPU 102 issues a processing start instruction to the data processing section 103. The processing start instruction is made by writing registers in the data processing section 103 through the first I/F section 208A and the second I/F section 208B.

According to the data processing start instruction from the CPU 102, the data processing section 103 starts processing data. Described below as an example of data processing is a case in which target data to be processed are RTP (Real-time Transport Protocol) packets that are sent from a monitoring camera and transmitted through a network, the RTP headers are eliminated from the RTP packets, and a video stream is extracted, as in the first embodiment.

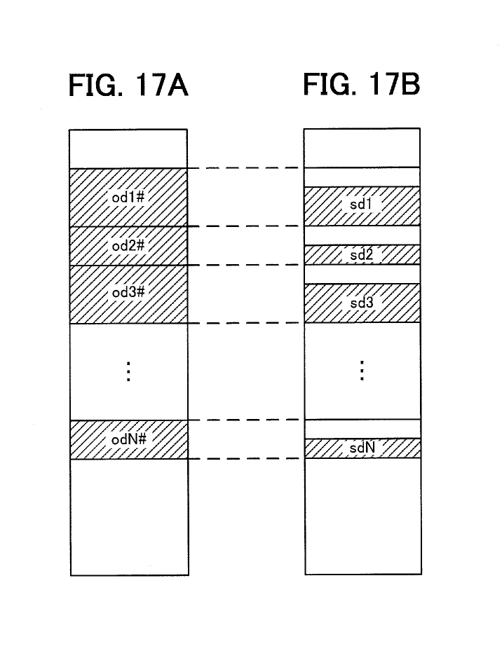

Each of areas od1#, od2#, od3#, . . . , odN# shown in FIG. 17A is assumed to be a single RTP packet. The data processing section 103 performs the same processing as in the first embodiment and obtains areas sd1, sd2, sd3, . . . , sdN where the video stream is stored, as shown in FIG. 17B, from the data in areas od1#, od2#, od3#, . . . , odN#

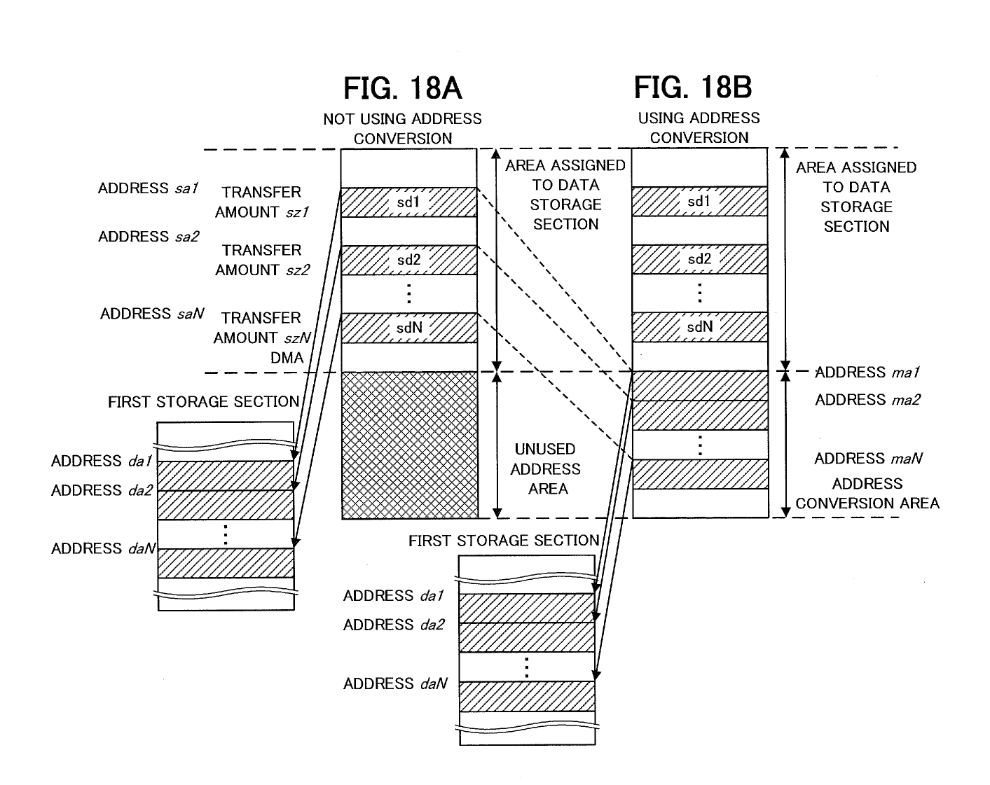

When the processing of the data processing section 103 proceeds and the processing of a predetermined amount of data or the processing of a predetermined group of data items is finished, the data processing section 103 generates an address conversion rule and storages the generated address conversion rule in the address conversion rule storage section 104, in the same way as the first embodiment. The address conversion rule is generated so that address conversion as shown in FIG. 18B, for example, may be performed. FIG. 18A shows a case of copying data without the address conversion. FIG. 18B shows a case of copying data with the address conversion. As shown in FIG. 18B, when the address conversion is performed, an address area that is not used in the case without the address conversion as shown in FIG. 18A is used, and the address conversion is performed in a way that areas sd1, sd2, . . . , sdN storing the video stream look like being stored at successive addresses. In the case shown in FIG. 18B, areas sd1 to sdN are successively assigned to unused addresses in the unused address area, such as area sd1 to address ma1 and area sd2 to address ma2. By doing this, the video stream data can be handled as if they were stored in a continuous area. An area to which addresses ma1, ma2, . . . , maN are assigned will hereafter be referred to as an address conversion area.

The address conversion rule stored in the address conversion rule storage section 104 is formed in a table format as shown in FIG. 13, for example, as in the first embodiment. By adopting this format, the address conversion section 105 can perform address conversion by means of simple hardware.

In addition, as in the first embodiment, each time the processing of a predetermined amount data or the processing of a predetermined group of data items (a predetermined number of data items) is finished, the data processing section 103 stores a partial address conversion rule in the address conversion rule storage section 104. Furthermore, address conversion rules which become unnecessary with the DMA section 106 copying data, which will be described later, are eliminated (deleted) from the address conversion rule storage section 104. By setting the address conversion rule as described above, the address conversion rule storage section 104 can be kept from becoming unnecessarily large.

The address conversion section 105 performs address conversion in accordance with the address conversion rule set in the address conversion rule storage section 104, as in the first embodiment. Accordingly, address conversion is performed only when the address conversion rule is present.

When the data processing section 103 has finished storing the address conversion rule in the address conversion rule storage section 104, it notifies the CPU 102 of the completion of data processing and also notifies the location (address conversion area) where the processed data are stored, as in the first embodiment.

Receiving the notification of completion of data processing from the data processing section 103, the CPU 102 performs settings for copying the data of the processing result to the DMA section 106. In the example shown in FIG. 18B, for example, address ma1 is set as a DMA transfer source address, da1 is set as a DMA transfer destination address, and szA is set as a transfer amount. Here, address ma1 corresponds to an address in the second data storage section 201B, and address da1 corresponds to an address in the first data storage section 201A. Address da1 is set, in the first data storage section 201A, a place convenient for the CPU 102 to perform subsequent processing. Finishing the setting of the DMA section 106, the CPU 102 instructs the DMA section 106 to start copying. These settings and instruction from the CPU 102 to the DMA section 106 are made through the first I/F section 208A and the second I/F section 208B, by setting registers in the DMA section 106. In the meantime, the address conversion section 105 does not execute address conversion and arrows register write access from the CPU 102 to the DMA section 106 to pass directly.

According to the copy start instruction from the CPU 102, the DMA section 106 copies data as in the first embodiment. However, the data transfer source is the second data storage section 201B, and the transfer destination is the first data storage section 201A.

This process makes a state in which the data in areas sd1 to sdN storing the video stream are stored continuously in order from address da1 specified by the CPU 102 in the first data storage section 201A. In this process, the CPU 102 has just specified transfer source address ma1, transfer destination address da1, and transfer size szA, and does not need to manage the transfer source address, transfer destination address, and transfer amount for each of areas sd1 to sdN storing the video stream. Consequently, the descriptor settings for DMA becomes unnecessary or simple. Since data copying from the second data storage section 201B to the first data storage section 201A becomes one-off DMA, data transfer through the first I/F section 208A and the second I/F section 208B becomes simple.

As in the first embodiment, when the data processing section 103 stores the partial address conversion rules in the address conversion rule storage section 104, if the identification numbers have been set for areas sd1, sd2, . . . , sdN shown in FIG. 18B according to order in which the DMA section 106 reads out, it becomes easy to refer to the addresses when the address conversion section 105 performs address conversion with reference to the address conversion rule table 120, and it becomes consequently possible to perform address conversion at a high speed with a simple hardware configuration.

In the configuration shown in FIG. 15, the address conversion rule storage section 104 and the second data storage section 201B may be formed in a single storage device, as in the first embodiment. In this case, the storage device for implementing the address conversion rule storage section 104 and the storage device implementing the second data storage section 201B can be incorporated into a single device, the hardware configuration can be simplified further, and cost of the device can be reduced. In this case, the address conversion rule storage section 104 may also be disposed in the second data storage section 201B. Further, in FIG. 15, the DMA section 106 may be connected to the second data bus 207B as well so that instructions and the like from the CPU 102 can be input directly to the DMA section 106, not through the address conversion section 105.

In the first and second embodiments described above, an unused address area of the data storage section 101 or the second data storage section 201B is used as the address conversion area, in other words, an unused address is used as a conversion address, but the embodiments are not limited to this example. For example, an imaginary address area which is not presence in the data storage section 101 or the second data storage section 201B can be used as the address conversion area, in other words, an imaginary address can be used as the conversion address.

### REFERENCE CHARACTERS

100, 200 information processing device, 101 data storage section, 201A first data storage section, 201B second data storage section, 102 CPU, 103 data processing section, 104 address conversion rule storage section, 105 address conversion section, 106 DMA section, 107 data bus, 207A first data bus, 207B second data bus, 208A first I/F section, 208B second I/F section, 240A first processing section, 240B second processing section, 500 CCTV system, 501 monitoring camera, 502 monitoring recorder, 503 network.

1. An information processing device comprising:
a storage section configured to store video data;
a DMA section configured to read video data from the storage section by specifying an address and write the read video data into the storage section or another storage section different from the storage section;
an address conversion rule storage section configured to store an address conversion rule for converting the address specified by the DMA section; and
an address conversion section configured to convert the address specified by the DMA section in accordance with the address conversion rule; wherein
the address conversion rule is a rule for converting addresses of a series of areas to addresses of the video data stored in a plurality of areas in the storage section;
the address conversion section includes an address conversion done-or-not determination section; and
the address conversion done-or-not determination section determines, by comparing the address specified by the DMA section with addresses of a third area assigned to address conversion, whether the address conversion is done or not done.

2. The information processing device of claim 1, wherein the video data are monitoring video data taken by a monitoring camera, transmitted through a network, and received.

3. The information processing device of claim 1, further comprising a data processing section configured to process the video data stored in the storage section: wherein
the data processing section generates the address conversion rule by associating the addresses of the plurality of areas where the processed video data are stored in the storage section with the addresses of the series of areas and stores the generated address conversion rule in the address conversion rule storage section.

4. The information processing device of claim 3, wherein the data processing section generates the address conversion rule by including at least one partial address conversion rule associating an address of the area where part of the processed video data is stored with an address of part of the series of areas.

5. The information processing device of claim 4, wherein the data processing section generates the partial address conversion rule each time a predetermined amount of video data or a predetermined number of video data items among the video data stored in the storage section is processed.

6. The information processing device of claim 4, wherein the address conversion section deletes the partial address conversion rule from the address conversion rule storage section in accordance with a state of video data transfer by the DMA section.

7. The information processing device of claim 4, wherein the partial address conversion rule is stored in the address conversion rule storage section in a way that order in which the video data are transferred by the DMA section is recognizable.

8. The information processing device of claim 1, wherein, when the address specified by the DMA section is included in the series of areas by referring to the address conversion rule, the address conversion section converts the specified address to a corresponding address in the plurality of areas.

9. The information processing device of claim 8, wherein, when the address specified by the DMA section is not included in the series of areas by referring to the address conversion rule, the address conversion section does not convert the specified address.

10. The information processing device of claim 3, further comprising a CPU configured to control the DMA section: wherein
the data processing section notifies the CPU of the series of areas;
the CPU instructs the DMA section to transfer video data in the series of areas notified by the data processing section.

11. The information processing device of claim 10, wherein the CPU further processes the video data processed by the data processing section.

12. The information processing device of, claim 1 wherein the series of areas is an area in which the video data are not stored in the storage section.

13. The information processing device of claim 1, wherein the series of areas is an imaginary areas which is not present in the storage section.

14. The information processing device of claim 1, wherein the storage section and the address conversion rule storage section are formed in a single storage device.

15. An information processing method comprising:
an address specification step of specifying an address of video data to be read from a storage section;
an address conversion step of converting the address specified in the address specification step in accordance with an address conversion rule;
a readout step of reading video data stored at the address converted in the address conversion step from the storage section; and
a step of writing the video data read in the readout step into the storage section or another storage section different from the storage section; wherein
the address conversion rule is a rule for converting addresses of a series of areas to addresses of the video data stored in a plurality of areas of the storage section; and
in the address conversion step, whether address conversion is done or not done is determined by comparing the address specified in the address specification step with addresses of a third area assigned to the address conversion.
